(19) United States
(12) Patent Application Publication
(10) Pub. No.: US 2013/0009502 A1
(43) Pub. Date: Jan. 10, 2013

(54) ELECTRICITY GENERATION DEVICE

(76) Inventor: Sheng-Lian LIN, Taoyuan City (TW)

(21) Appl. No.: 13/537,040

(22) Filed: Jun. 28, 2012

(30) Foreign Application Priority Data
Jul. 8, 2011 (CN) 201120255892.1

(51) Int. Cl. H02K 47/14

(52) U.S. Cl. 310/113

(57) ABSTRACT

The electricity generation device is for fully harnessing the power of a continuously rotational member of an electrical appliance. The electricity generation device is installed on the continuously rotational member of an external device, and contains a rotational assembly configured on the external device and having an axle running axially through the rotational assembly, and a generator axially mounted on the axle. The axle is axially connected to an axle of the external device and is engaged by a power system of the external device to spin continuously. As such, the generator starts producing electricity so that the rotational energy of the axle is converted and recycled into electrical energy continuously.

### TECHNICAL FIELD OF THE INVENTION

The present invention is generally related to electricity generation devices, and more particularly to an electricity generation device for harnessing the power of a continuously rotational member of an electrical appliance.

### DESCRIPTION OF THE PRIOR ART

As more electrical appliances are put to use, there is more energy consumption and waste. Recycling energy is also getting more attention.

In the various electrical appliances, a significant portion of them involves some continuously rotational parts. One example is the heat dissipation fan utilized in many appliances such as air conditioners. This rotational part usually transforms electricity to a different kind of energy, which is not effectively recycled.

### SUMMARY OF THE INVENTION

An electricity generation device is therefore provided herein for harnessing the power of a continuously rotational member of an electrical appliance.

The electricity generation device is installed on a continuously rotational member of an external device. The electricity generation device contains a rotational assembly configured on the external device and having an axle running axially through the rotational assembly, and a generator axially mounted on the axle. The axle is axially connected to an axle of the external device and is engaged by a power system of the external device to spin continuously.

Preferably, the electricity generation device further contains a battery connected to the generator.

Preferably, the electricity generation device further contains a voltage regulator connected to an output port of the generator.

Preferably, the generator is a brushless generator.

The rotational assembly and the generator are mounted axially on the axle of the external device. As the axle is driven into continuous rotation, the generator starts producing electricity so as to convert the rotational energy of the axle into electrical energy The kinetic energy of the axle's rotation is thereby effectively recycled. The battery stores surplus energy for future usage. The voltage regulator is for processing the power recycled by the generator so that steady electricity is produced. The generator is a brushless generator so as to reduce the loss from the friction between the axle and the generator, to enhance energy conversion efficiency, and to recycle more power.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing an installation environment of an electricity generation device according to an embodiment of the present invention.

FIG. 2 is a perspective break-down diagram showing the major components of the electricity generation device of FIG. 1.

FIG. 3 is a perspective schematic diagram showing an application scenario of the electricity generation device of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

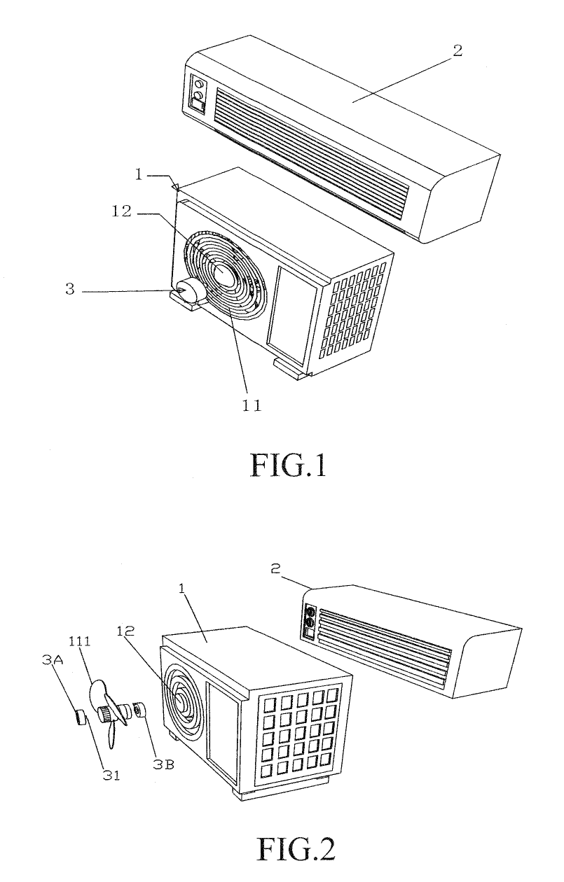

The electricity generation device of the present invention has to work with an external device with a continuously rotational member such as the split-type air conditioner shown in FIG. 1. An indoor unit 2 is installed in the house to cool down the room temperature. An outdoor unit 1 is installed outside the house to continuously expel the heat produced by the indoor unit 2 by a built-in rotational assembly 11. The rotational assembly 11 is mounted axially on an axle 12 which is engaged by a power system of the outdoor unit 1. The power system continuously provides power to the axle 12 so that the axle 12 as well as the rotational assembly 11 spins at a specific speed.

In order to guarantee the heat is quickly dissipated, the axle 12 as well as the rotational assembly 11 has to be driven at a higher rotational speed, higher than what is required to simply rotate the rotational assembly 11. We therefore can install a small electricity generation device on the axle 12 to recycle the power consumed by the axle 12,

As shown in FIG. 1, a generator 3 is installed on the axle 12 of the outdoor unit 1. The generator 3 and the rotational assembly 11 are aligned axially. In other words, the axis of the generator 3 and the axis of the rotational assembly 11 are aligned linearly. An axle 31 of the generator 3 is connected to the axle 12.

As shown in FIG. 2, assuming that the rotational assembly 11 is a heat dissipation fan 111, the installation of the generator 3 is as follows. Firstly, the fax ill is axially mounted on the axle 12. Then, the generator 3's axle 31 is joined to the axle 12, as shown in FIG. 2's 3A. Alternatively, the generator 3 is axially mounted on the axle 12. Then, the fan 111 is installed on the axle 12 in front of the generator 3, as shown in FIG. 2's 3B. In other words, the generator 3 can be installed before or after the fan 111. The location of the generator 3 has no impact to its functionality.

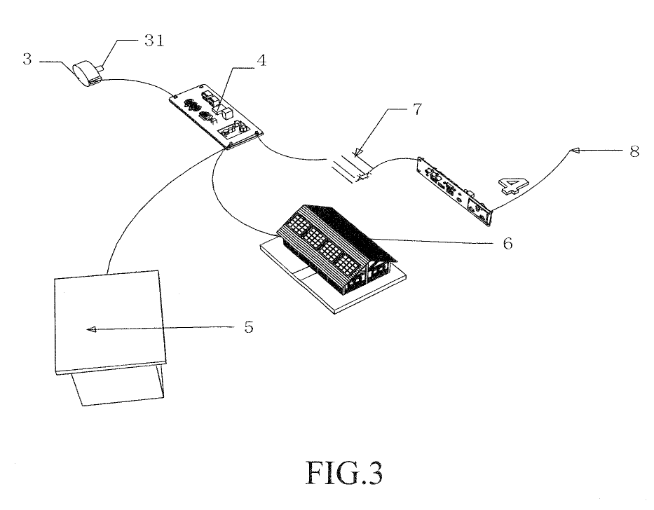

Additionally, as shown in FIG. 3, the electricity generation device further contains a voltage regulator 4 connected to an output port of the generator 3. In other words, the power recycled by the generator 3 is processed by the voltage regulator 4 so that steady electricity is produced.

Additionally, as shown in FIG. 3, the electricity generation device further contains a battery 7 connected to an output port of the voltage regulator (or connected to the output port of the generator 3). The battery 7 stores surplus energy or stores some energy for emergency use.

To reduce loss and to enhance energy conversion efficiency, the generator 3 is a brushless generator so as to reduce the loss from the friction between the axle 31 and the generator 3, and to recycle more power by reducing the load to the axle 12.

The electricity generation device enjoys higher recycling efficiency. A small increase to the axle 12's rotational speed can result in high percentage of power recycle. The electricity produced by the electricity generation device can be continuously utilized and recycled. As shown in FIG. 3, the recycled energy can be delivered to a power plant 5 or directly to a household 6, recycled to an electricity provisioning board 8 of the air conditioner, or stored in the battery 7 as backup power.

The rotational assembly and the generator are mounted axially on the axle of the external device. As the axle is driven into continuous rotation, the generator starts producing electricity so as to convert the rotational energy of the axle into electrical energy. The kinetic energy of the axle's rotation is thereby effectively recycled. The battery stores surplus energy for future usage. The voltage regulator is for processing the power recycled by the generator so that steady electricity is produced. The generator is a brushless generator so as to reduce the loss from the friction between the axle and the generator, to enhance energy conversion efficiency, and to recycle more power.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electricity generation device installed on an external device having a continuously rotational member; comprising:
an rotational assembly configured on the external device and having an axle running axially through the rotational assembly; and
a generator axially mounted on the axle; and
wherein the axle is axially connected to an axle of the external device and is engaged by a power system of the external device to spin continuously.

2. The electricity generation device according to claim 1, further comprising a battery connected to the generator.

3. The electricity generation device according to claim 1, further comprising a voltage regulator connected to an output port of the generator.

4. The electricity generation device according to claim 1, wherein the generator is a brushless generator.

5. The electricity generation device according to claim 2, wherein the generator is a brushless generator.

6. The electricity generation device according to claim 3, wherein the generator is a brushless generator.
